(19) United States
(12) Patent Application Publication
(10) Pub. No.: US 2012/0262963 A1
(43) Pub. Date: Oct. 18, 2012

(54) MULTI-PHASE RECTIFIER OF ALTERNATOR

(75) Inventor: Chen-Ku Wei, Taipei (TW)

(73) Assignee: MOBILETRON ELECTRONICS CO., LTD, Taichung City (TW)

(21) Appl. No.: 13/085,721

(22) Filed: Apr. 13, 2011

(51) Int. Cl. H02M 7/06

(52) U.S. Cl. 363/126

(57) ABSTRACT

The present invention provides a multi-phase rectifier of an alternator having a plurality of phases, and each of the phases include at least a positive rectifying device and at least a negative rectifying device. The negative rectifying device includes a schottky diode and a diode with reverse breakdown effect in parallel connection. An anode of the schottky diode is connected to the input port and a cathode thereof is connected to a negative terminal of the output port. Therefore, the multi-phase rectifier of the present invention may have a low power loss and protective function in high voltage.

### BACKGROUND OF THE INVENTION

1. Field of the Invention

The present invention relates generally to a rectifier, and more particularly to a multi-phase rectifier of an alternator.

2. Description of the Related Art

A conventional alternator, such as the car alternator, is provided with a voltage regulator and a rectifier to convert alternating current to direct current for charging the battery or other purposes.

The conventional rectifier for high voltage and high current has a plurality of phases, and each phase includes two P-N junctions in serial connection to resist the extreme voltage, it usually is about 250V, generated by the alternator. However, the forward voltage drop of the P-N junction is about 1V that will cause some power loss in the alternator (assume the alternator generates 150 A current, that will have about 150 W power loss). This power loss will be transferred into heat and make the rectifier overheat so that the rectifier usually is provided with a heat sink to cool it down. As the output of the alternator going greater, it needs bigger diode wafer and bigger heat sink for thermal dissipation. However, it will make the alternator bigger and heavier and the thermal expansion of the wafer can't be ignored anymore.

In order to reduce effect of the extreme voltage of the alternator, more and more alternators in the present time are provided with avalanche diodes instead of P-N junctions. The avalanche breakdown of the avalanche diode will keep the voltage under a predetermined value (about 23V) that the alternator will not be damaged by the extreme voltage. The avalanche diode servers both functions of rectification and absorbing the extreme voltage that the avalanche diode generates much more heat than the P-N junction. Therefore, the avalanche diode needs bigger wafer and bigger heat sink than the P-N junction, and it still is easier damaged because of overheat.

Another improved heavy duty alternator is provided with a rectifier with two P-N junctions in parallel connection. The parallel connected P-N junctions may share the thermal effect of the power loss to reduce the thermal effect. However, the forward voltage drop of the P-N junction has negative temperature coefficient that the forward voltage drop is greater as the temperature is higher. As a result, the current flows to the P-N junction, which has a lower forward voltage drop, and makes the P-N junction's temperature too high to share the current.

In conclusion, there are some parts in the conventional rectifiers to be improved.

### SUMMARY OF THE INVENTION

The primary objective of the present invention is to provide a multi-phase rectifier of an alternator, which has a low power loss and protective function in high voltage.

According to the objective of the present invention, the present invention provides a multi-phase rectifier of an alternator including an input port to receive an alternating current, and an output port to output a direct current. The multi-phase rectifier has a plurality of phases, and each of the phases include at least a positive rectifying device and at least a negative rectifying device. The positive rectifying device has two ends connected to the input port and the positive terminal of the output port respectively. The negative rectifying device has two ends connected to the input port and the negative terminal of the output port respectively. The negative rectifying device includes a schottky diode and a diode with reverse breakdown effect in parallel connection, and an anode of the schottky diode is connected to an anode of the diode and a cathode of the schottky diode is connected to a cathode of the diode, and the schottky diode has the anode connected to the input port and the cathode connected to the negative terminal of the output port.

### BRIEF DESCRIPTION OF THE DRAWINGS

FIG. 1 is a circuit diagram of a first preferred embodiment of the present invention;

FIG. 2 is a circuit diagram of the first preferred embodiment of the present invention, showing the current flow in positive rectification;

FIG. 3 is a circuit diagram of the first preferred embodiment of the present invention, showing the current flow in negative rectification;

FIG. 4 is a circuit diagram of a second preferred embodiment of the present invention;

FIG. 5 is a circuit diagram, showing that rectifier of the present invention is incorporated in the Y-connection, three-phase alternator; and

FIG. 6 is a circuit diagram, showing that the rectifier of the present invention is incorporated in the Y-connection, three-phase, four-wire alternator.

### DETAILED DESCRIPTION OF THE INVENTION

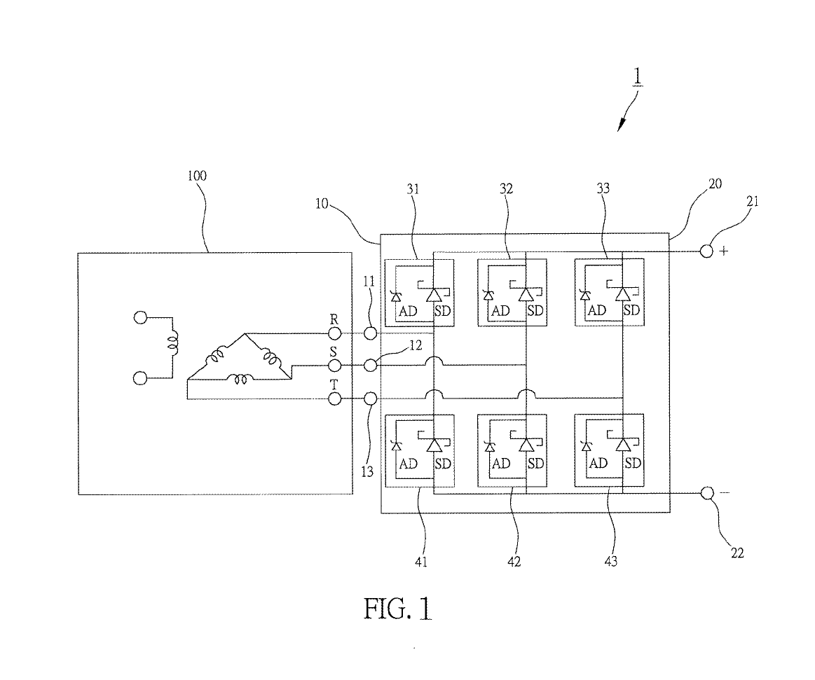

FIG. 1 shows a multi-phase rectifier 1 of the first preferred embodiment of the present invention. The rectifier 1 is incorporated in a delta-connection, three-phase alternator 100 to convert alternating current (AC) to direct current (DC). The rectifier 1 includes an input port 10, an output port 20, three positive rectifying devices 31˜33, and three negative rectifying devices 41˜43.

The input port 10 receives the three-phase AC from the alternator 100. The input port 10 includes an R-phase terminal 11, an S-phase terminal 12, and a T-phase terminal 13, and these terminals are connected to R-phase, S-phase, and T-phase terminals of the alternator 100 respectively.

The output port 20 is connected to an electronic device or circuit to output DC after rectification. The output port 20 has a positive terminal 21 and a negative terminal 22 to be an anode and a cathode respectively.

The positive rectifying devices 31˜33 include the R-phase positive rectifying device 31, the S-phase positive rectifying device 32, and the T-phase positive rectifying device 33. Each positive rectifying devices 31˜33 has an end connected to positive terminal 21 of the output port 20, and the other ends of the positive rectifying devices 31˜33 are connected to the R-phase terminal 11, the S-phase terminal 12, and the T-phase terminal 13 of the input port 10 respectively. Each positive rectifying devices 31˜33 includes a schottky diode (SD) and an avalanche diode (AD) of reverse breakdown in parallel connection, and the anode of the schottky diode (SD) is connected to the anode of the avalanche diode (AD) and the cathode of the schottky diode (SD) is connected to the cathode of the avalanche diode (AD). The schottky diodes (SD) of the positive rectifying devices 31˜33 have the anodes connected to the positive terminal 21 of the output port 20 and the cathodes connected to the input port 10.

The negative rectifying devices 41˜43 includes the R-phase negative rectifying device 41, the S-phase negative rectifying device 42, and the T-phase negative rectifying device 43. Each negative rectifying devices 41˜43 has an end connected to negative terminal 21 of the output port 20, and the other ends of the negative rectifying devices 41˜43 are connected to the R-phase terminal 11, the S-phase terminal 12, and the T-phase terminal 13 of the input port 10 respectively. Each negative rectifying devices 41˜43 includes a schottky diode (SD) and an avalanche diode (AD) of reverse breakdown in parallel connection, and the anode of the schottky diode (SD) is connected to the anode of the avalanche diode (AD) and the cathode of the schottky diode (SD) is connected to the cathode of the avalanche diode (AD). The anodes of the schottky diodes (SD) of the negative rectifying devices 41˜43 are connected to the input port 10, and the cathodes thereof are connected to the negative terminal 21 of the output port 20.

The schottky diode (SD) has low forward voltage drop (less than 0.6V) that the current flows to the schottky diode (SD) more than to avalanche diode (AD). Besides, the schottky diode (SD) has low power loss in consistent current because of the low forward voltage drop as well that it generate less heat in rectification. As a result, it needs a smaller wafer and a smaller heat sink than the conventional device.

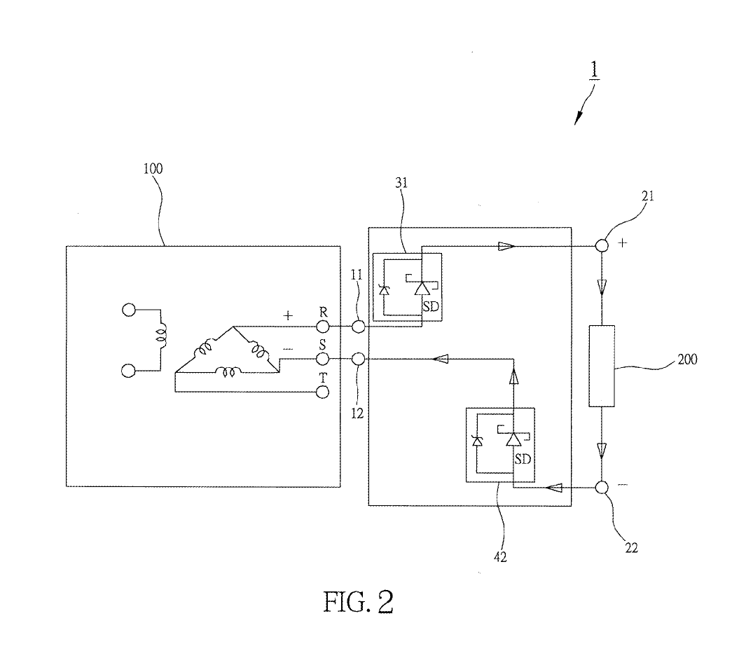

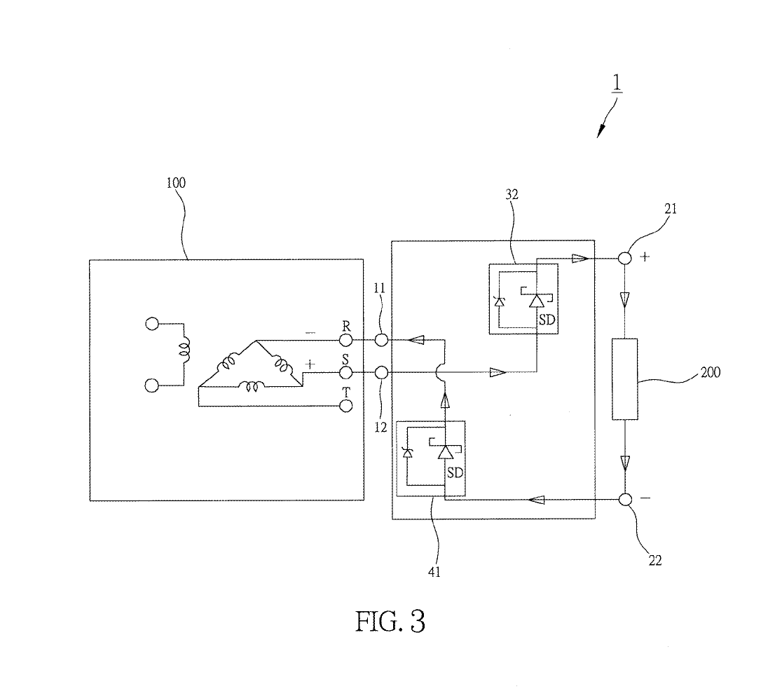

As shown in FIG. 2, take R-S phase power of the alternator 100 for example, when the R-S phase power is positive, the current from the alternator 100 flows through the schottky diode (SD) of the R-phase positive rectifying device 31 via the R-phase terminal 11, and flows to a load 200, such as a battery, through the positive terminal 21 of the output port 20, and then flows back to the schottky diode (SD) of the S-phase negative rectifying device 42, and finally flows back to the alternator 100 via the S-phase terminal 12. On the contrary, when the R-S phase power is negative, as shown in FIG. 3, the current from the alternator 100 flows through the schottky diode (SD) of the S-phase positive rectifying device 32 via the S-phase terminal 12, and flows to the load 200 through the positive terminal 21 of the output port 20, and then flows back to the schottky diode (SD) of the R-phase negative rectifying device 41, and finally flows back to the alternator 100 via the R-phase terminal 11. Therefore, with the combination of rectifications as shown in FIG. 2 and FIG. 3, the multi-phase rectifier 1 of the present invention has a full-wave rectification. The rectifications of S-T phase power and T-S phase power are the same as above, so we do not describe the detail again.

The parallel connection of the schottky diode (SD) and the avalanche diode (AD) may provide both characters of low voltage drop and low reverse bias voltage (the highest voltage is about 200V). The alternator 100 generates high current and high voltage that the schottky diode (SD) may be damaged by the extreme voltage. However, with the parallel connection of the schottky diode (SD) and the avalanche diode (AD), the avalanche diode (AD) will arise reverse breakdown and generate a reverse breakdown voltage (about 19V˜23V) when the extreme voltage occurs that the avalanche diode (AD) may absorb the extreme voltage to keep the potential between the anode and the cathode of the schottky diode (SD) under the reverse breakdown voltage. In other words, it may protect the schottky diode (SD) as long as the reverse bias voltage of the schottky diode (SD) is about 25V. Besides, the schottky diode (SD) will have a low reverse bias voltage when it has a low forward voltage drop that the schottky diode (SD) used in the present invention will have a low forward voltage drop as well. It is known that the low forward voltage drop of the diode may have a low power loss in rectification. The only job of the avalanche diode (AD) is to absorb the extreme voltage that the temperature of the avalanche diode (AD) is easier to be kept in an acceptable range and it only needs small wafer and small heat sink.

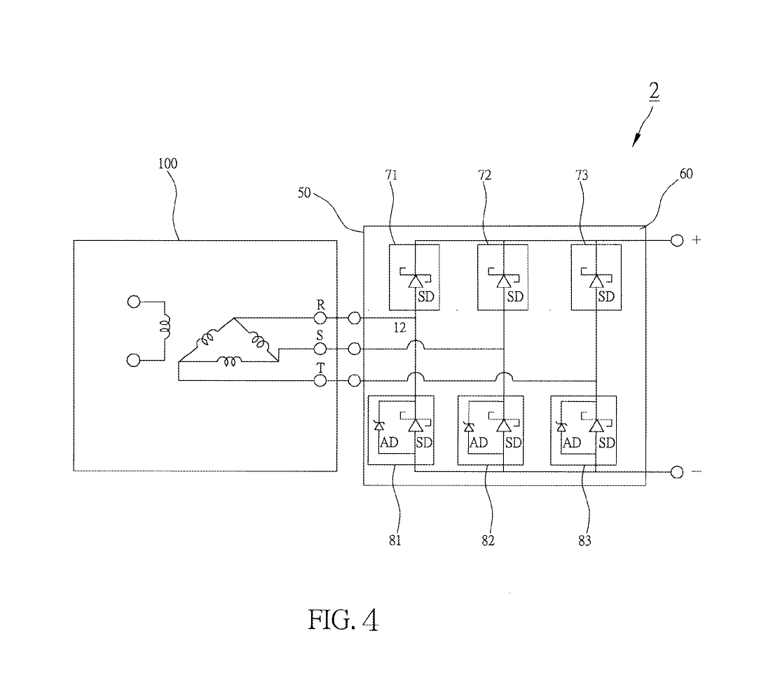

As shown in FIG. 4, a multi-phase rectifier 2 of the second preferred embodiment of the present invention is incorporated in the delta-connection, three-phase alternator 100 also to convert AC to DC. The multi-phase rectifier 2, the same as above, includes an input port 50, an output port 60, three positive rectifying devices 71˜73, and three negative rectifying devices 81˜83. The different part of the second preferred embodiment is that each positive rectifying devices 71˜73 has a schottky diode (SD) only. It is known that the direction of current is opposite to the direction of electron flow, therefore a large number of electrons will flow to the negative rectifying devices 81˜83 when the extreme voltage occurs, and the negative rectifying devices 81˜83 are provided with avalanche diodes (AD) to absorb the extreme voltage. That may achieve the purpose of protecting the schottky diodes (SD) under the extreme voltage. Besides, the temperature of the rectifier 2 of the second preferred embodiment in rectification is lower than the rectifier 1 of the first preferred embodiment because the rectifier 2 has fewer components than the rectifier 1 that the wafer and heat sink used in the rectifier 2 of the second preferred embodiment may be smaller.

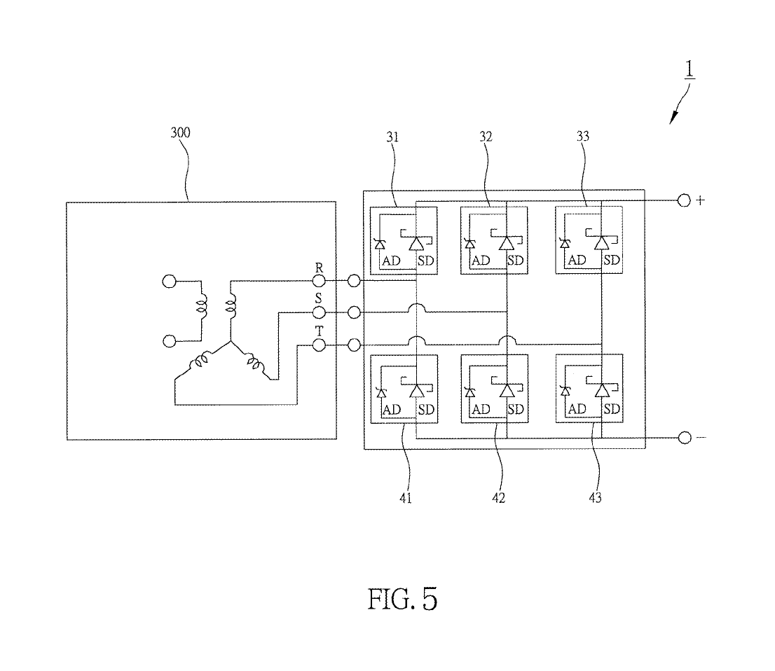

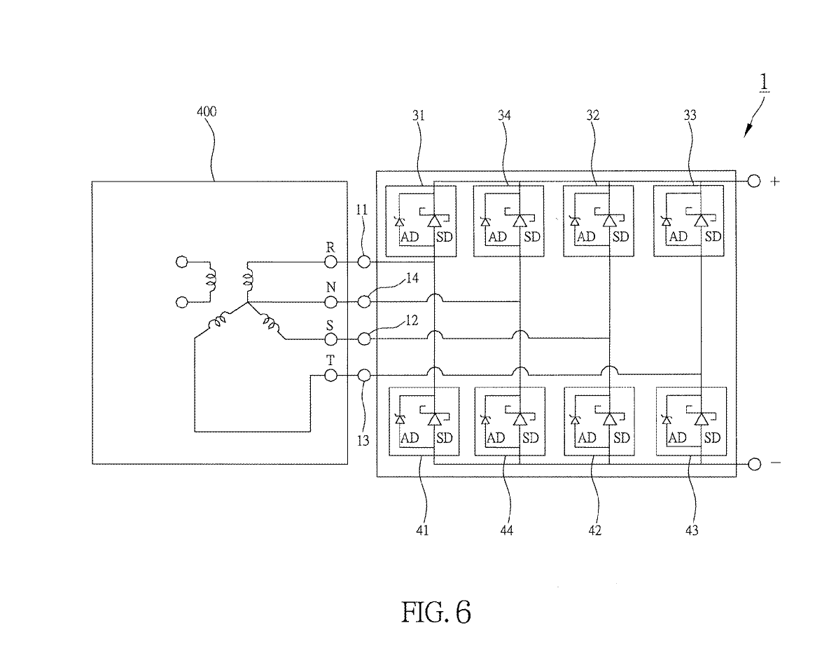

The rectifier of the present invention may be incorporated in a delta-connection, three-phase alternator also. FIG. 5 shows rectifier 1 of the first preferred embodiment incorporated in a delta-connection, three-phase alternator 300. FIG. 6 shows another rectifier of the present invention, which is similar to the rectifier 1 of the first preferred embodiment, having four positive rectifying devices 31˜34, four negative rectifying devices 41˜44, and a center-trap 14 in the input port that the rectifier may be incorporated in a Y-connection, three-phase, four-wire alternator 400. The rectifier 1 shown in FIG. 6 may achieve the same functions as above. In addition, the rectifier of the present invention may be incorporated in other types of alternator also.

Except the avalanche diode, zener diode and transient voltage suppressor (TVS), both of which have reverse breakdown effect, may be used to protect the rectifier in high voltage.

The character of the present invention is that the negative rectifying device is provided with a schottky diode (SD) and an avalanche diode (AD) in parallel connection to achieve the functions of low power loss and protection in high voltage. The positive rectifying device, however, may have any component that may rectify. All of the equivalences are till in the scope of claim construction of the present invention.

In conclusion, the rectifier of the multi-phase alternator of the present invention has a low power, and it further has the protective function in high voltage.

The description above is a few preferred embodiments of the present invention and the equivalence of the present invention is still in the scope of claim construction of the present invention.

What is claimed is:

1. A multi-phase rectifier of an alternator, comprising an input port to receive an alternating current, and an output port to output a direct current, wherein the multi-phase rectifier has a plurality of phases, and each of the phases include:
at least a positive rectifying device having two ends connected to the input port and the positive terminal of the output port respectively; and
at least a negative rectifying device having two ends connected to the input port and the negative terminal of the output port respectively, wherein the negative rectifying device is connected to the positive rectifying device in series connection, and the negative rectifying device includes a schottky diode and a diode with reverse breakdown effect in parallel connection, and an anode of the schottky diode is connected to an anode of the diode and a cathode of the schottky diode is connected to a cathode of the diode, and the schottky diode has the anode connected to the input port and the cathode connected to the negative terminal of the output port.

2. The multi-phase rectifier as defined in claim 1, wherein the positive rectifying device includes a schottky diode, and the schottky diode has an anode connected to the input port and a cathode connected to the positive terminal of the output port.

3. The multi-phase rectifier as defined in claim 2, wherein the positive rectifying device further includes a diode with reverse breakdown effect connected to the schottky diode in parallel connection, and the anode of the schottky diode is connected to an anode of the diode and the cathode of the schottky diode is connected to a cathode of the diode.

4. The multi-phase rectifier as defined in claim 3, wherein the diode with reverse breakdown effect is an avalanche diode.

5. The multi-phase rectifier as defined in claim 1, wherein the diode with reverse breakdown effect is an avalanche diode.

6. The multi-phase rectifier as defined in claim 1, wherein the positive rectifying device includes an R-phase positive rectifying device, an S-phase positive rectifying device, and a T-phase positive rectifying device, and the negative rectifying device includes an R-phase negative rectifying device, an S-phase negative rectifying device, and a T-phase negative rectifying device, and the input port includes an R-phase terminal, an S-phase terminal, and a T-phase terminal, wherein ends of the R-phase positive rectifying device, the S-phase positive rectifying device, and the T-phase positive rectifying device are connected to the R-phase terminal, the S-phase terminal, and the T-phase terminal of the input port respectively, and opposite ends of the R-phase positive rectifying device, the S-phase positive rectifying device, and the T-phase positive rectifying device are connected to the positive terminal of the output port, and ends of the R-phase negative rectifying device, the S-phase negative rectifying device, and the T-phase negative rectifying device are connected to the ends of the R-phase positive rectifying device, the S-phase positive rectifying device, and the T-phase positive rectifying device respectively, and opposite ends of the R-phase negative rectifying device, the S-phase negative rectifying device, and the T-phase negative rectifying device are connected to the negative terminal of the output port.

7. The multi-phase rectifier as defined in claim 1, wherein the positive rectifying device includes an R-phase positive rectifying device, an S-phase positive rectifying device, a T-phase positive rectifying device, and, an N-phase positive rectifying device, and the negative rectifying device includes an R-phase negative rectifying device, an S-phase negative rectifying device, a T-phase negative rectifying device, and, an N-phase negative rectifying device, and the input port includes an R-phase terminal, an S-phase terminal, a T-phase terminal, and an N-phase center-trap, wherein ends of the R-phase positive rectifying device, the S-phase positive rectifying device, the T-phase positive rectifying device, and the N-phase positive rectifying device are connected to the R-phase terminal, the S-phase terminal, the T-phase terminal, and the N-phase center-trap of the input port respectively, and opposite ends of the R-phase positive rectifying device, the S-phase positive rectifying device, the T-phase positive rectifying device, and the N-phase positive rectifying device are connected to the positive terminal of the output port, and ends of the R-phase negative rectifying device, the S-phase negative rectifying device, the T-phase negative rectifying device, and the N-phase negative rectifying device are connected to the ends of the R-phase positive rectifying device, the S-phase positive rectifying device, the T-phase positive rectifying device, and the N-phase positive rectifying device respectively, and opposite ends of the R-phase negative rectifying device, the S-phase negative rectifying device, the T-phase negative rectifying device, and the N-phase positive rectifying device are connected to the negative terminal of the output port.
